(19) United States
(12) Patent Application Publication
(10) Pub. No.: US 2004/0118659 A1
(43) Pub. Date: Jun. 24, 2004

(54) Method and system for operating a semiconductor factory

(76) Inventors: Clinton Haris, Lunenberg, MA (US); Sven Hahn, Wachau (DE); Karli Hantzschmann, Dresden (DE); Andreas Wintergerst, Dresden (DE); Thomas Bauer, Maxhutte-Haidhof (DE); Dieter Schneider, Dresden (DE); Guy Davis, Austin, TX (US); Martin Peiter, Dresden (DE)

Correspondence Address: FREESCALE SEMICONDUCTOR, INC., LAW DEPARTMENT, 7700 WEST PARMER LANE MD:TX32/PL02, AUSTIN, TX, 78729, US

(21) Appl. No.: 10/327,191

(22) Filed: Dec. 20, 2002

(51) Int. Cl. B65G 49/07

(52) U.S. Cl. 198/345.3; 414/935

(57) ABSTRACT

The present invention relates to a method and a system for operating a semiconductor factory. The factory comprises equipment (8) for processing semiconductor wafers, and an automated material handling system (12). The invention comprises clamping a wafer carrier (16) while a wafer is processed by a particular tool (10), continuing clamping the wafer carrier (16) after processing, and unclamping the wafer carrier (16) when the automated material handling system (12) is ready for removing the wafer carrier (16) from the tool (10).

### FIELD OF THE INVENTION

The present invention generally relates to a method of operating a semiconductor factory, and more particularly to a method of operating a semiconductor factory comprising an automated material handling system. The present invention further relates to a system for operating a semiconductor factory.

### BACKGROUND OF THE INVENTION

In semiconductor factories wafers are processed sequentially by various tools. Such manufacturing involves moving a wafer carrier from one type of apparatus to another. For example, wafers that have been subjected to a process in a wafer deposition chamber may have to be moved to another apparatus in which they are cleaned and dried; then the wafers may be transferred to a different apparatus for additional processing steps. The wafer carriers are, for example, realized as front-opening unified pods (FOUP).

There are different possibilities to move a wafer carrier from one tool to another. One possibility is that an operator manually removes a carrier from one tool and transfers it to another tool. Another possibility is that the carrier is removed and transferred by an automated material handling system (AMHS).

Once a wafer carrier has been transported to a particular tool, the wafer is processed by the tool. During such processing, the wafer carrier is held by a mechanism that is associated to the tool. After processing the wafer, the wafer is released and transferred to the wafer carrier, which is subsequently released so that it can be picked up and transferred to another tool.

In such a situation problems may occur, in particular, if a wafer carrier has been moved to a specific tool by an automated material handling system. After releasing the wafer carrier it may happen, that an operator manually removes the wafer carrier from the tool. In such case, the automated material handling system will find no wafer carrier when it arrives at the tool for picking up the carrier. Thus, the automated material handling system must go through a complicated error recovery scenario to determine what to do next.

The present invention seeks to solve the above mention problems by providing a method and a system for operating a semiconductor factory in which both operators and automated material handling systems are employed.

### BRIEF DESCRIPTION OF THE DRAWINGS

The present invention is illustrated by way of example and is not limited by the accompanying figures, in which like references indicate similar elements.

FIG. 1 shows a schematic view of a semiconductor factory comprising an automated material handling system in accordance with an embodiment of the present invention;

FIG. 2 is a first part of a flowchart illustrating a method according to one embodiment of the present invention; and

FIG. 3 is a second part of a flowchart illustrating a method according to one embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF PREFERRED EMBODIMENTS

According to the present invention, a method of operating a semiconductor factory is provided, the semiconductor factory includes:

equipment 8 for processing semiconductor wafers, the equipment 8 including a plurality of tools 10 having a mechanical device 18 that upon activation prevents a wafer carrier 16 from being removed from a particular tool (i.e., the mechanical device 18 clamps the wafer); and

an automated material handling system 12, the method includes:

securing a wafer carrier 16 by a mechanical device 18 of a particular tool 10 while a wafer is processed by the particular tool 10,

continuing securing the wafer carrier 16 by the mechanical device 18 of the particular tool 10 after processing the wafer by the particular tool 10, and

releasing (e.g., unclamping) the wafer carrier 16 when the automated material handling system 12 is ready for removing the wafer carrier 16 from the tool 10.

According to the present invention, there is further provided a system for operating a semiconductor factory, the semiconductor factory includes:

equipment 8 for processing semiconductor wafers, the equipment 8 includes a plurality of tools 10, and

an automated material handling system 12, the system includes:

mechanical device 18 associated to a particular tool 10 for clamping a wafer carrier 16 while a wafer is processed by the particular tool 10, and

means for unclamping the wafer carrier 16 only when the automated material handling system 12 is ready for removing the wafer carrier 16 from the tool 10.

Load ports are part of the wafer processing tools 10 and are where the wafer carrier 16 is located when transferring the wafer form the wafer carrier to a chamber within the wafer processing tools and vice versa. The load ports have a mechanical device 18 for holding the carrier during processing of the wafer. Thus, originally, the clamping is intended to prevent an operator from removing the carrier while wafers are processed. In one embodiment, the wafer carriers are clamped even longer by the mechanical device 18 until the automatic material handling system is ready for removing the wafer carrier from the tool, which may occur when the automated material handling system arrives at the tool.

The arrival of the automated material handling system is signaled through the assertion of a SEMI standard handshake protocol (E23 or E84). Upon assertion of this protocol, the carrier should be unclamped (and/or undocked) from the tool. An alternative method would be for the automated material handling system to signal to the host that the automated material handling system has arrived at the tool. The host would then subsequently signal the tool to unclamp (and/or undock) the carrier via a command (SECS/GEM (SEMI Equipment Communication Standard/Generic Equipment Model)). Thus, in one embodiment after the automated material handling system (12) is ready for removing the wafer carrier (16) from the equipment (8), the automated material handling system (12) transmits a request signal to the equipment (8) for removing the wafer carrier (16), the equipment (8) receives the request signal and unclamps the wafer carrier (16), the equipment (8) transmits a ready signal to the automated material handling system (12), and the automated material handling system (12) receives the ready signal and unloads the carrier (16). Therefore, the wafer carrier 16 will be at the tool when the automated material handling system arrives and, preferably, will not be manually removed by an operator. Consequently, the automated material handling system need not go through a complicated error recovery, as in prior art cases, when a wafer carrier was removed earlier by an operator. An operation of a factory with both operators and automated material handling systems is improved.

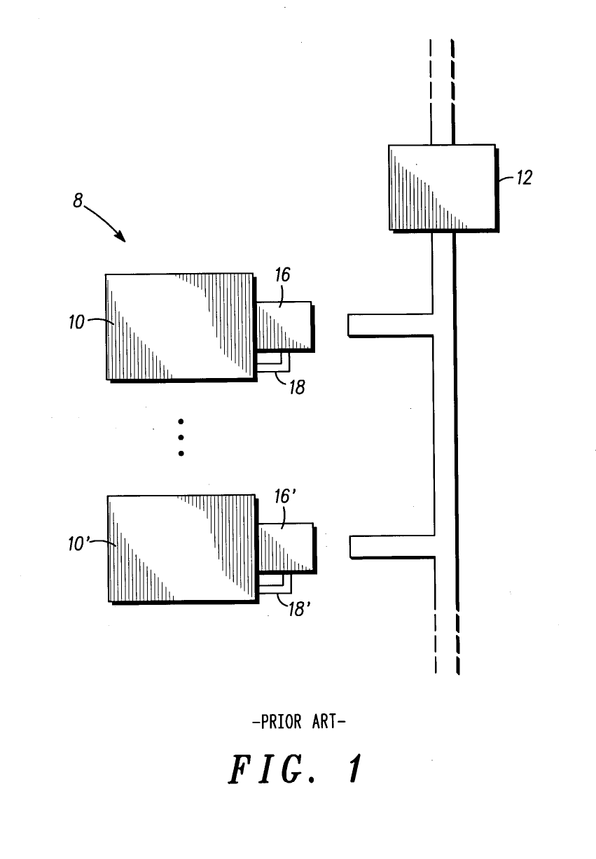

FIG. 1 shows a schematic view of a semiconductor factory comprising an automated material handling system 12. A semiconductor factory is provided with equipment 8 that comprises several tools 10, 10′. Each of these tools 10, 10′, for example tool 10, is provided with a mechanical device 18 for clamping a wafer carrier 16. In one embodiment, the mechanical device 18 is a clamp that is L-shaped. The longer apertures of the L-shaped claim is parallel to a base plate of the wafer carrier 16 when the wafer carrier 16 is not in contact with a particular tool of the plurality of tools 10. To secure the wafer carrier 16 to the base plate, the longer apertures of the L-shaped clamp is rotated so it is perpendicular to the base plate to fasten the wafer carrier 10 to the particular tool. In another embodiment, the clamp is-a T-shaped device that is located in the base plate of the wafer carrier and rotates to lock the wafer carrier 16 to the particular tool.

An automated material handling system 12 is provided that is able to remove wafer carriers 16 from a tool 10, transfer the wafer carriers 16 to a different tool 10′, so that the wafer carrier 16 can be clamped by the different tool 10′. The clamping means 18 are also provided in prior are systems. However, the clamping is released as soon as the wafer processing is terminated and the wafer has been transferred back to the wafer carrier 16.

The present invention provides a new method and system that can be achieved without hardware changes. Accordingly, the clamping is released only when the automated material handling system 12 signals that it is ready for removing the wafer carrier 16 from the tool 10, which is generally the case, when the automated material handling system 12 arrives and the tool 10.

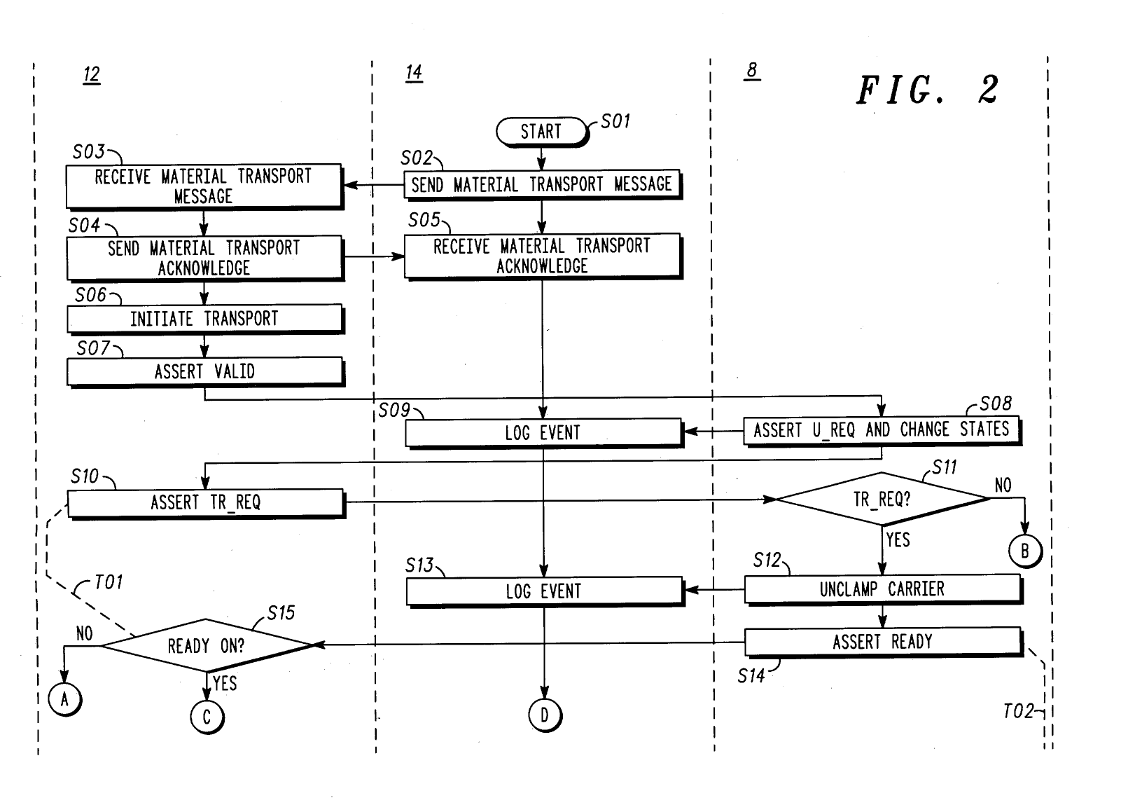

FIG. 2 is a first part of a flowchart illustrating a method according to the present invention. The flow-chart is subdivided into the three columns, namely the process steps of the equipment 8, the process steps of the automated material handling system 12, and the process steps of the host 14.

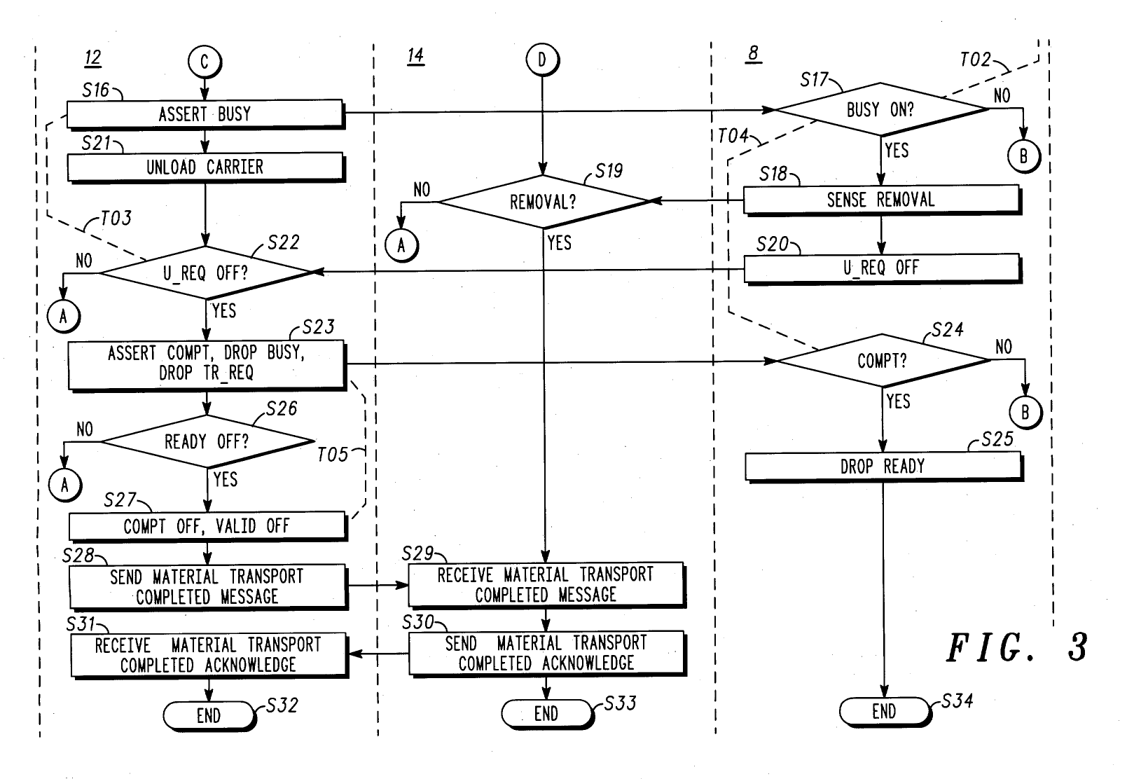

The method starts at step S01. It continues at step S02 by sending a material transport message from the host 14 to the automated material handling system 12. In step S03 the material transport message is received by the automated material handling system 12. In step S04 a material transport acknowledge is sent from the automated material handling system 12 to the host 14, and the material transport acknowledge is received by the host 14 in step S05. In step S06 the transport is initiated and in step S07, advantageously when the automated material handling system 12 arrives at the tool 10, a VALID signal is asserted by the automated material handling system 12. In step S08 the equipment 8 asserts a U₁₃ REQ signal in response to the asserted VALID signal. Further, the load port state changes, and a “load port state change” event report is sent to the host 14. The host 14 logs the event in step S09. In step S10 the automated material handling system 12 asserts a TR₁₃ REQ signal in response to the equipment's 8 asserted U₁₃ REQ signal. The equipment sends a TR₁₃ REQ signal when a carrier transfer process is about to occur, whereas a U_REQ is sent when the carrier unload process is about to occur. Further, the automated material handling system 12 starts a timeout T01 (i.e., a pause, or wait in which the system either does nothing or waits, listens or looks for a particular event to occur). During this timeout, TO1 the time is monitored until a READY signal is asserted by the equipment 8 after unclamping the carrier. After asserting the TR_REQ signal by the automated material handling system 12, step S11 determines whether the TR_REQ signal is present. If it is present, the carrier is unclamped in step S12, and an event report “carrier unclamped” is transmitted to the host 14 and logged by the host 14 in step S13. In step S14, the equipment 8 asserts a READY signal and starts a timeout TO2. During this timeout TO2, the system waits until the automated material handling system 12 responds as BUSY. In step S15, the automated material handling system 12 judges whether the READY signal is on. If the READY signal is on, the process continuous as shown in FIG. 3. Further, the timeout TO1 is terminated. If the READY signal is off any error handling process can be performed, which is shown as ‘A’ in FIG. 2. The error handling process may be unique to the equipment. Examples of appropriate error responses can include the triggering of a buzzer, a flashing light, resetting the system, stopping all future action, the like, or combinations of the above.

FIG. 3 is a second part of a flowchart illustrating a method according to the present invention. Again, the flowchart is subdivided into the three columns, namely the process steps of the equipment 8, the process steps of the automated material handling system 12, and the process steps of the host 14. In step S16 a BUSY is asserted by the automated material handling system 12. Further a timeout TO3 is started which tests, if the carrier is not removed from the equipment 8. In step S17 it is judged by the equipment 8, whether the BUSY signal is on. Further, the timeout TO2 is stopped and a timeout TO4 is started. The timeout TO4 tests, if the removal procedure is not completed. If the BUSY signal is on, in step S18 a REMOVAL is sensed. (If the BUSY signal is off, an error handling process is performed. A process similar to that discussed in step s15 of FIG. 12 can be used.)

Further, an event report “carrier removed” is sent to the host 14. In step S19 it is judged by the host 14 whether the REMOVAL signal is present. If the REMOVAL is present (i.e., the answer to the question of removal is yes), the sequence of host 14 processing steps may proceed to step S29 that is described further below. (If the REMOVAL is not present, an error handling process is performed. A process similar to that discussed in step s15 of FIG. 12 can be used.)

In step S20 the signal U₁₃ REQ is set off. In step S21 the carrier is unloaded either manually by a person or automatically by a robot. Step S22 judges whether the signal U₁₃ REQ is off. U₁₃ REQ is the signal that the equipment sends when a carrier unload process is about to occur. IF the U₁₃ REQ is off (i.e., it sends a yes, signal the timeout TO3 is stopped and in step S23 the complete signal COMPT is asserted. Further the signals BUSY and TR₁₃ REQ are dropped (i.e., the signals go from a ‘high’, ‘in’ or ‘1’ state to a ‘low’, ‘off’ or ‘0’ state, respectively.) IF the U₁₃ REQ is on then an error handling process is performed. A process similar to that discussed in step s15 of FIG. 12 can be used.

Then, in step S23 the timeout TO5 is started that tests if the equipment 8 does not finish the handshake. Step S24 judges, whether the signal COMPT, which stands for complete, is present. The COMPT signal is the indicator for determining if the equipment has completed the transfer of the carrier. Further, the timeout TO4 is stopped. If the signal COMPT is present (i.e., the answer to the COMPT question is yes), in step S25 the signal READY is dropped. (If the COMP signal is not present, an error handling process is performed. A process similar to that discussed in step s15 of FIG. 12 can be used.)

In step S26 it is judged, whether the signal READY is off. If the signal READY is off, in step S27 the signals COPMT and VALID are set off. (IF the READY is on then an error handling process is performed. A process similar to that discussed in step s15 of FIG. 12 can be used.)

Further, the timeout TO5 is stopped. In step S28 the material transport completed message is sent from the automated material handling system 12 to the host 14. In step S29 the host 14 receives the material transport completed message. In step S30 the host 14 sends the material transport completed acknowledge back to the automated material handling system 12 that receives the material completed acknowledge in step S31. In steps S32, S33 and S34 the method ends with respect to the automated material handling system 12, the host 14, and the equipment 8, respectively.

If an electrical or mechanical error or timeout occurs during operation, the equipment 8 will generate an alarm. The equipment 8 will then drop and clean up any signals (for example E23) for that load port and it will send an SECS alarm message along with alarming the tool 10 interface and waiting for operator intervention. The SECS alarm may include the job identification, the port number, the alarm code, the alarm identification and the alarm text that describes the current alarm condition and/or the timeouts that were exceeded.

While the invention has been described in terms of particular structures, devices and methods, those of skill in the art will understand based on the description herein that it is not limited merely to such examples and that the full scope of the invention is properly determined by the claims that follow.

1. A method of operating a semiconductor factory, the semiconductor factory comprising
equipment (8) for processing semiconductor wafers, the equipment (8) comprising a plurality of tools (10) having clamping means (18) for clamping wafer carriers (16), and
an automated material handling system (12), the method comprising the steps of
clamping a wafer carrier (16) by clamping means (18) of a particular tool (10) while a wafer is processed by the particular tool (10),
continuing clamping the wafer carrier (16) by the clamping means (18) of the particular tool (10) after processing the wafer by the particular tool (10), and
unclamping the wafer carrier (16) when the automated material handling system (12) is ready for removing the wafer carrier (16) from the tool (10).

2. The method according to claim 1, wherein the automated material handling system (12) signals to the equipment (8) that it is ready for removing the wafer carrier (16) from the tool (10).

3. The method according to claim 1, wherein the automated material handling system (12) signals to a host (14) that it is ready for removing the wafer carrier (16) from the tool (10).

4. The method according to claim 1, wherein, after the automated material handling system (12) has become ready for removing the wafer carrier (16) from the equipment (8),
the automated material handling system (12) transmits a request signal to the equipment (8) for removing the wafer carrier (16),
the equipment (8) receives the request signal and unclamps the wafer carrier (16),
the equipment (8) transmits a ready signal to the automated material handling system (12), and
the automated material handling system (12) receives the ready signal and unloads the carrier (16).

5. The method according to claim 1, wherein times between method steps are monitored.

6. The method according to claim 1, wherein unclamping the wafer carrier (16) is performed when the automatic material handling system (12) arrives at the tool (10).

7. A system for operating a semiconductor factory, the semiconductor factory comprising
equipment (8) for processing semiconductor wafers, the equipment (8) comprising a plurality of tools (10), and
an automated material handling system (12), the system comprising
clamping means (18) associated to a particular tool (10) for clamping a wafer carrier (16) while a wafer is processed by the particular tool (10), and
means for unclamping the wafer carrier (16) only when the automated material handling system (12) is ready for removing the wafer carrier (16) from the tool (10).

8. The system according to claim 7, wherein the automated material handling system (12) signals to the equipment (8) that it is ready for removing the wafer carrier (16) from the tool (10).

9. The system according to claim 7, wherein the automated material handling system (12) signals to a host (14) that it is ready for removing the wafer carrier (16) from the tool (10).

10. The system according to claim 7, wherein, after the automated material handling system (12) has become ready for removing the wafer carrier (16) from the equipment (8),
the automated material handling system (12) transmits a request signal to the equipment (8) for removing the wafer carrier (16),
the equipment (8) receives the request signal and unclamps the wafer carrier (16),
the equipment (8) transmits a ready signal to the automated material handling system (12), and
the automated material handling system (12) receives the ready signal and unloads the carrier (16).

11. The system according to claim 7, wherein means for monitoring times between different system states are provided.

12. The system according to claim 7, wherein unclamping the wafer carrier (16) is performed when the automatic material handling system (12) arrives at the tool (10).
